(19) United States
(12) Patent Application Publication
(10) Pub. No.: US 2024/0270333 A1
(43) Pub. Date: Aug. 15, 2024

(54) Systems, devices, articles, and methods for active suspension with a human-in-the-loop

(71) Applicant: EXOSAPIEN TECHNOLOGIES, North Vancouver (CA)

(72) Inventors: Jonathan Tippett, Squamish (CA); Curtis Perrin, Vancouver (CA)

(21) Appl. No.: 18/435,959

(22) Filed: Feb. 7, 2024

Related U.S. Application Data
(60) Provisional application No. 63/484,408, filed on Feb. 10, 2023.

(51) Int. Cl. B62D 57/028; B60G 17/00

(52) U.S. Cl. CPC B62D 57/028; B60G 17/00

(57) ABSTRACT

A vehicle including a frame, a plurality of controls coupled to the frame which in response to input from a pilot provides signals, and a plurality of legs coupled to the frame. Each respective leg in the plurality of legs includes one or more bodies, a proximal end rotatably coupled to the frame, and a distal end. The vehicle further includes a plurality of actuators associated with the plurality of legs communicatively coupled to the plurality of controls. A respective actuator in the plurality of actuators moves in response to a signal from a respective control in the plurality of controls, the respective actuator in the plurality of actuators is associated with a respective leg in the plurality of legs, and in response to the motion of the respective actuator, the respective leg in the plurality of legs changes between a first pose characterized by a first position of the distal end of the respective leg and a second pose characterized by a second position of the distal end of the respective leg.

### TECHNICAL FIELD

The disclosure pertains to the field of controllable vehicles including those carrying a pilot. The disclosure relates to a vehicle including an adjustable suspension that in response to pilot input independently places a respective part of the vehicle in contact with an underlying surface at a height relative to the vehicle. Further aspects of the disclosure relate to human-in-the-loop operation of the suspension system of a vehicle.

### BACKGROUND

### Description of the Related Art

The field of controllable vehicles includes those that walk on legs, move by tracks, or move by wheels. A walking vehicle is a vehicle that moves on legs and feet rather than wheels or tracks. Walking vehicles include those with one or more legs.

### SUMMARY

A vehicle including a frame, a plurality of controls coupled to the frame which in response to input from a pilot provides signals, and a plurality of legs coupled to the frame. Each respective leg in the plurality of legs includes one or more bodies, a proximal end rotatably coupled to the frame, and a distal end. The vehicle further includes a plurality of actuators associated with the plurality of legs communicatively coupled to the plurality of controls. A respective actuator in the plurality of actuators moves in response to a signal from a respective control in the plurality of controls, the respective actuator in the plurality of actuators is associated with a respective leg in the plurality of legs, and in response to the motion of the respective actuator, the respective leg in the plurality of legs changes between a first pose characterized by a first position of the distal end of the respective leg and a second pose characterized by a second position of the distal end of the respective leg.

A suspension system including a body including a proximal end and a distal end, and a support mechanically coupled to the distal end of the body. The suspension system further includes a shock mechanically coupled to the body and in response to a force on the support lessens the effect of the force on the proximal end of the body, and an actuator mechanically coupled in series with the shock, and in response to a control signal, moves the support away from the proximal end of the body.

A vehicle substantially as shown and described herein.

A suspension system as shown and described herein.

A kit substantial as shown and described herein.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

Systems, devices, articles, and methods are described in greater detail herein with reference to the following figures in which:

FIG. 1 is a technical diagram illustrating, in elevation view, a first vehicle in a first pose;

FIG. 2 is a technical diagram illustrating, in elevation view, the first vehicle in an alternative arrangement, a second pose;

FIG. 3 is a technical diagram illustrating, in plan view, the first vehicle in the second pose;

FIG. 4 is a technical diagram illustrating, in elevation view from a different angle, the first vehicle;

FIG. 5 is a technical diagram illustrating, in elevation view, a second vehicle in the first pose;

FIG. 6 is a technical diagram illustrating, in elevation view, the second vehicle in the second pose;

FIG. 7 is a technical diagram illustrating, in perspective view, the second vehicle in a third pose;

FIG. 8 is a schematic diagram illustrating a pilot and a plurality of controls;

FIG. 9 is a schematic diagram illustrating a part of a vehicle including active and passive suspension; and

FIG. 10 is a technical diagram in elevation and detailed view illustrating a part of a vehicle including active and passive suspension elements.

In the drawings, the same reference numbers identify similar elements or acts. In the drawings, angle, size, and relative position of elements are not necessarily shown to scale. For example, some of these elements may be enlarged or positioned to improve drawing legibility. Further, the shapes of any elements as drawn, are not necessarily intended to convey any information regarding the actual shape of the particular elements and may have been solely selected for ease of illustration or recognition.

### DETAILED DESCRIPTION

One type of walking vehicle is a mech including a frame, a plurality of legs, a plurality of powered joints, and a plurality of controls, all operatively coupled to provide ambulation of the mech. A pilot sits within the frame surrounded by an exoskeletal harness, and provides inputs to a plurality of controls; each join is controlled individually through one or more associated actuators. The pilot needs to exert themselves with motion and force (e.g., push, pull, isometric exercise, isotonic exercise). Pilots find the task intuitive, but it takes days for a new pilot to learn how to make the mech walk.

The present disclosure involves systems, devices, articles, and methods which in operation implement a vehicle that allows a pilot to start operating the vehicle with controlled motion in tens of seconds. A vehicle normally includes a plurality of supports which in operation can be brought into contact with the underlying surface (e.g., ground). For example, bottom, ball caster, caster, endless track, foot, pontoon, ski, spike, and wheel. The disclosure relates to a vehicle including an adjustable suspension that in response to pilot input independently places a first respective support at a first height relative to the frame and second respective support at a second. Defining heights relative to the frame allows for a better description when embodiments of the present invention are used on uneven ground. Further aspects of the disclosure relate to a human-in-the-loop operation of the suspension system of a vehicle.

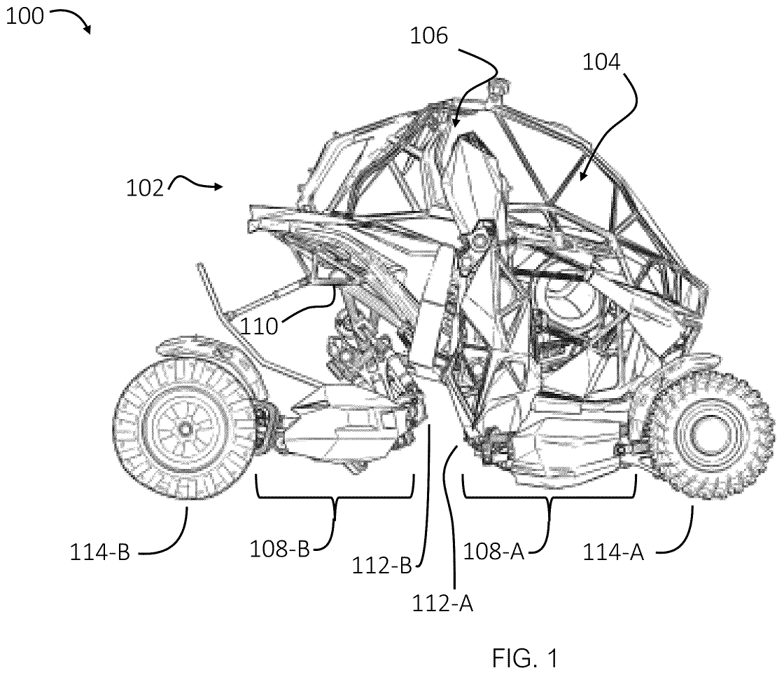

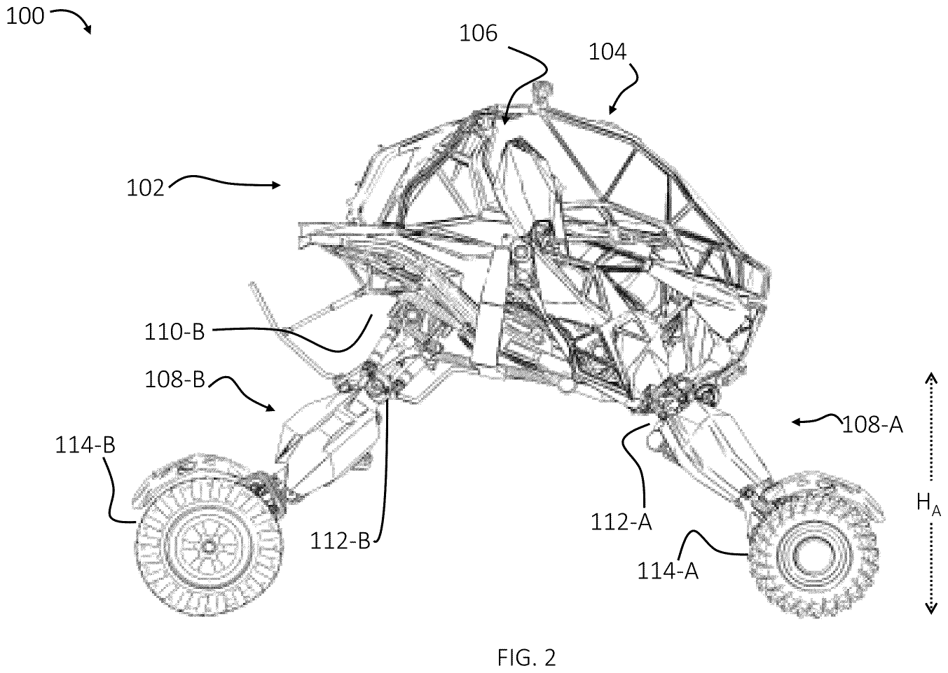

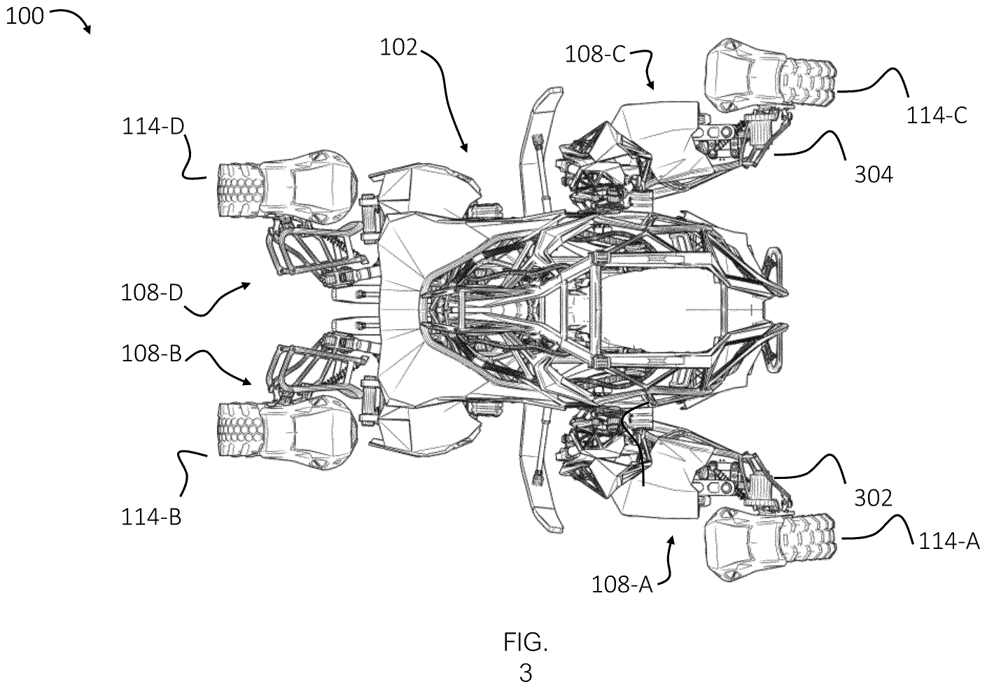

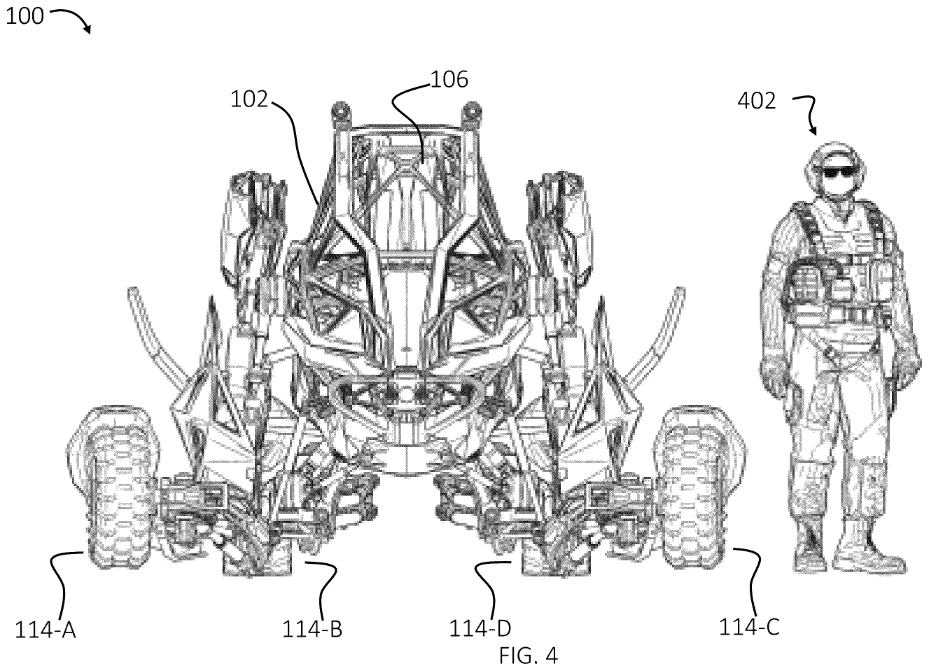

Looking at the drawings in overview, note the following. FIG. 1 includes a first vehicle in a first pose. FIG. 2 includes the first vehicle in a second pose. The first pose is different from the second pose. FIG. 3 includes the first vehicle shown in plan view. FIG. 4 includes the first vehicle shown in elevation view and from a different angle than used in FIG. 1 and FIG. 2. The vehicle includes a plurality of legs.

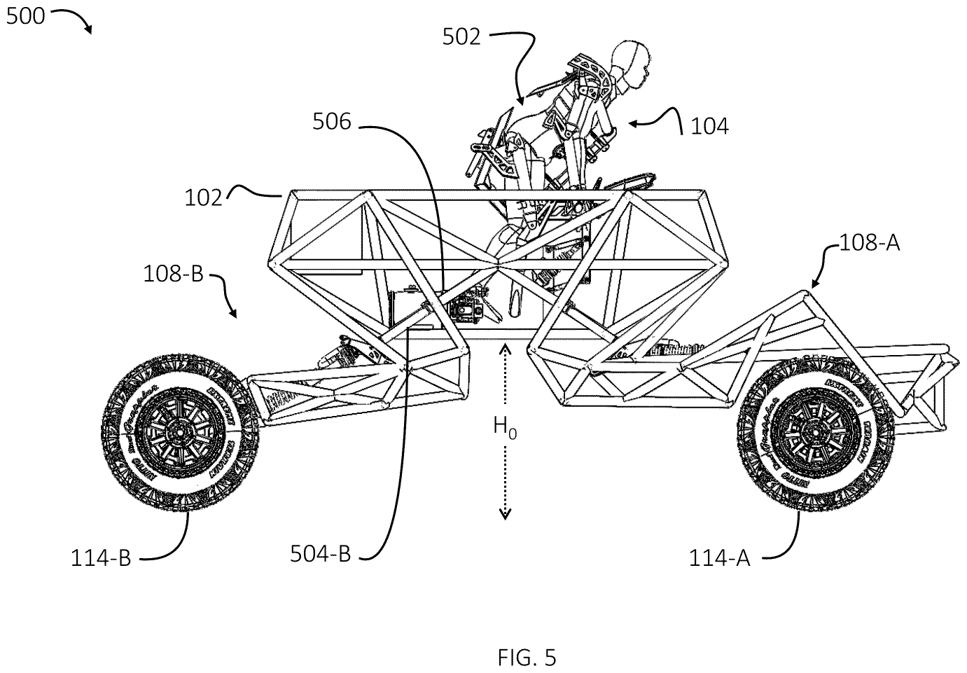

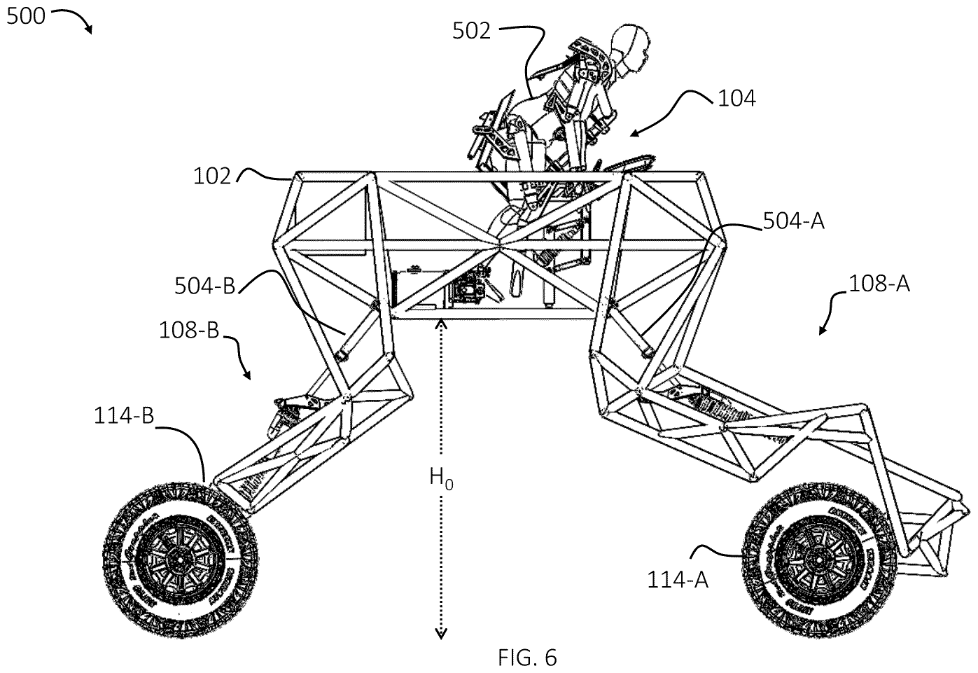

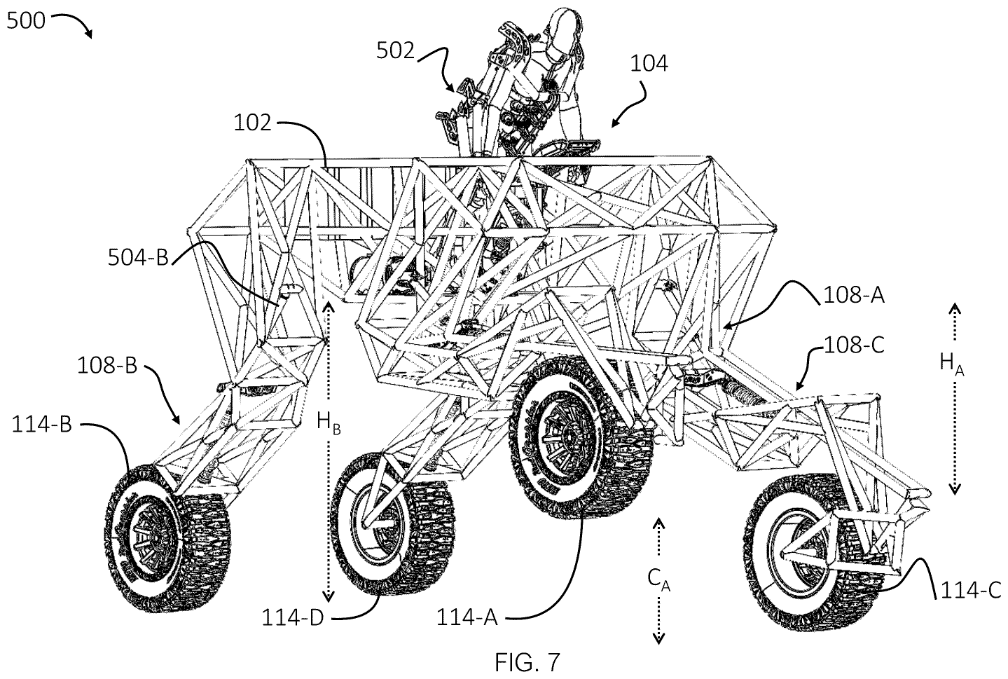

FIG. 5, FIG. 6, and FIG. 7 include a second vehicle in the first pose, the second pose, and a third pose, respectively. The views focus on the structures and functions of the vehicle including removing the plastics or panels to show shocks and actuators. The views also include a pilot, a plurality of controls, and a harness. The vehicle in FIG. 5 and FIG. 6 is shown at different heights—squat and standing positions. The second vehicle appears in FIG. 7 in an alternative view and a third pose. In particular, a support is at a different height. See the front right wheel is lifted independently of the remaining wheels.

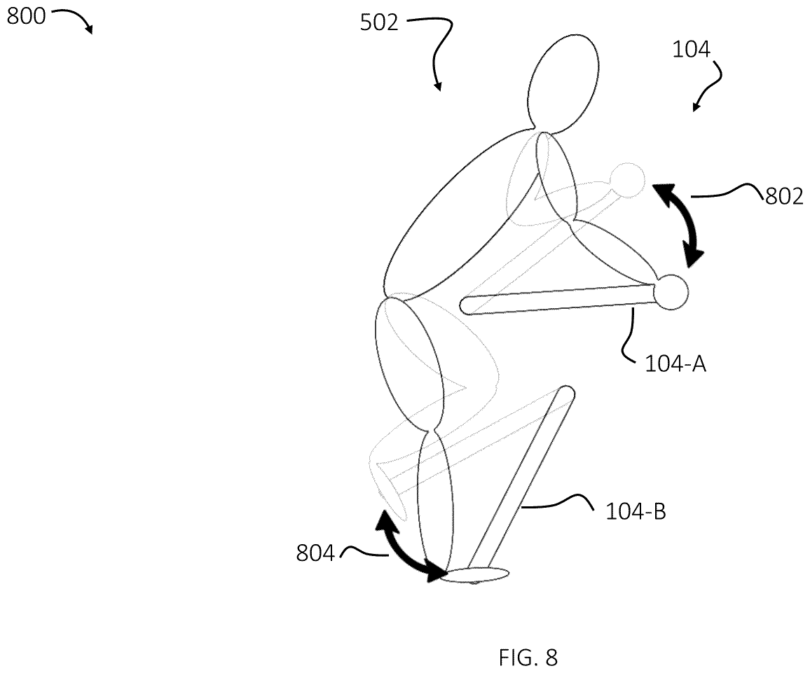

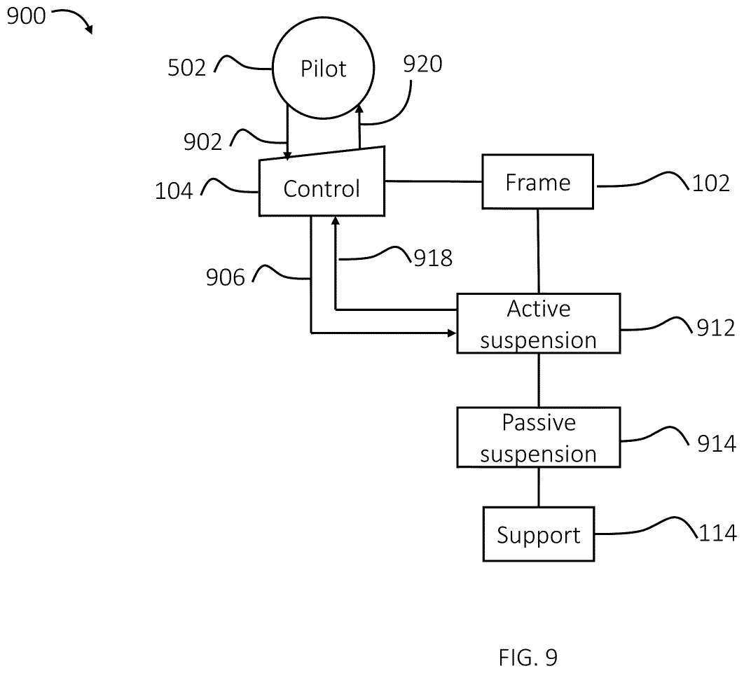

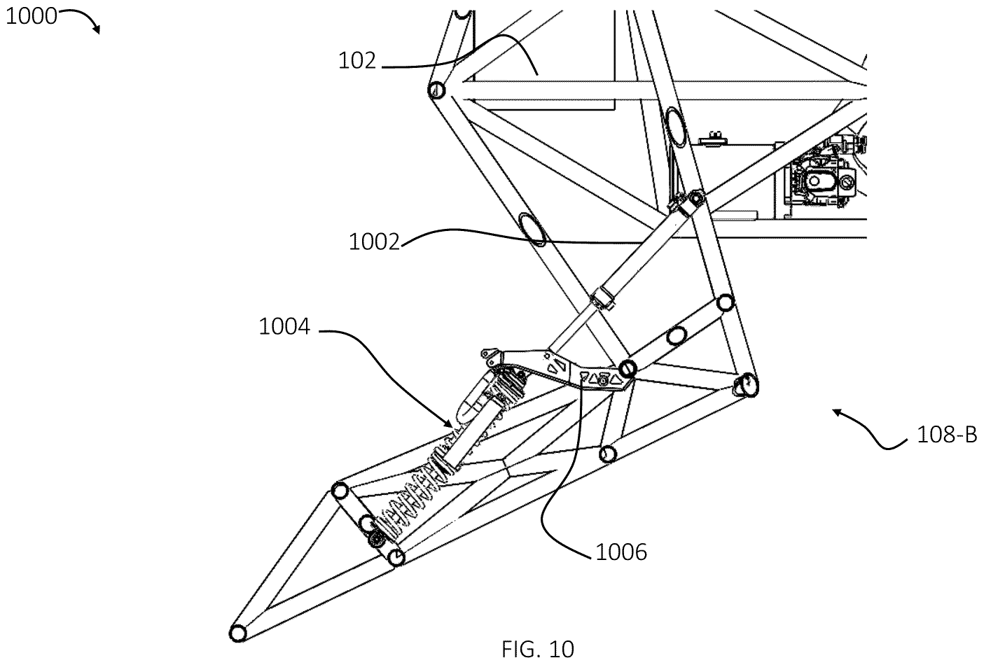

FIG. 8 is a schematic diagram illustrating a pilot and a plurality of controls. FIG. 9 is a schematic diagram illustrating a part of a vehicle including active and passive suspension. In response to input at the plurality of controls the heights of the support change. The pilot thus can engage in active suspension control. The vehicle in response to the input adjusts the height of the vehicle including mean clearance or individual heights for a respective support (e.g., wheel). The individual height control allows for several vehicle functions including steering by leaning, pose control for levelling, cornering, weight distributing, weight accommodation, traction control, obstacle avoidance, terrain adaptation, suspension tuning (e.g., stiffness, damping), and the like. FIG. 10 is a technical diagram illustrating a part of a vehicle including active and passive suspension elements.

Turning to FIG. 1 which shows an exemplary vehicle 100 in accordance with the systems, devices, articles, and methods of embodiments described herein. Vehicle 100 is an example of a vehicle that provides one or more aspects of this disclosure as described above. Various components of vehicle 100 described or shown are optional in presence or number (e.g. omitted, present in a plurality, present singly), or may be split or combined according to various embodiments described herein. Vehicle 100 includes a chassis or frame 102, a plurality of controls 104, a harness 106 for an operator or pilot (not shown), and a plurality of legs 108. In some embodiments, vehicle 100 includes two pluralities of joints. As shown, the plurality of legs 108 includes a first plurality of joints 110 and a second plurality of joints 112. Vehicle 100 further includes a plurality of supports 114 coupled to frame 102 by plurality of legs 108.

Frame 102 provides a rigid structure that may include an on-board motor, power supply, sensors, lighting or the like. The plurality of legs 108 is movably coupled to frame 102 by first plurality of joints 110. For example, the legs are rotatably coupled and have, at least, a swing degree of freedom parallel to the sagittal plane or equivalently the major access of frame 102. Frame 102 includes a plurality of controls 104 placed proximate harness 106 and in response to input from the pilot the plurality of controls 104 moves with respect to frame 102 and act as input to the first plurality of joints 110 and second plurality of joints 112. Controls 104 are mapped to the first plurality of joints 110 and the second plurality of joints 112. In some embodiments, controls 104 rotate (e.g., swing). The joints may align with the joints of the pilot's limbs. For example, controls 104 may receive motions from the pilot such as adduction, abduction, flexion, and extension.

The plurality of legs 108 is movably connected to frame 102 by first plurality of joints 110. In some embodiments, as shown in FIG. 1, each respective leg in the plurality of legs 108 includes a plurality of bodies. A respective first body is proximally disposed and coupled to frame 102 by a respective joint in the first plurality of joints 110. A respective second body is distally disposed and coupled to frame 102 by a respective joint in the second plurality of joints 112, the respective first body, and a respective joint in the first plurality of joints 110.

In some embodiments, vehicle 100 includes a plurality of supports 114 coupled to the distal end of the plurality of legs 108. Examples include wheels as shown but may include supports selected from the group consisting of ball casters, casters, endless tracks, feet, pontoons, skis, spikes, and wheels. In some embodiments, the plurality of supports 114 includes supports of all the same type. In some other embodiments, the plurality of supports 114 includes supports of mixed type. For example, a pair of skis and a pair of wheels. In some embodiments, the plurality of supports 114 includes an extra support formed from, or located at, the underside of frame 102.

Vehicles described herein such as vehicle 100 may adopt two or more poses: arrangements of parts of vehicle 100. For example, vehicle 100 may have a pose charactered by the position (e.g., angle, displacement) of the plurality of legs 108 relative to frame 102. In some embodiments, the pose of vehicle 100 is characterized by the position of plurality of legs 108, and plurality of supports 114 relative to frame 102. In yet other embodiments, pose of vehicle 100 is characterized by the relative position of the plurality of legs 108, first plurality of joints 110, second plurality of joints 112, and plurality of supports 114. For example, as shown in FIG. 1 vehicle 100 assume a seated pose; underside of the plurality of supports 114 is about the same height as the bottom of frame 102.

Turning to FIG. 2 which shows vehicle 100 in accordance with the systems, devices, articles, and methods of embodiments described herein. Vehicle 100 is in a second pose different from the first pose shown in FIG. 1. Vehicle 100 includes frame 102, plurality of controls 104, harness 106, plurality of legs 108, and plurality of supports 114. The pose of vehicle 100 allows a better view of plurality of legs 108 including to the first plurality of joints 110 and the second plurality of joints 112.

In some implementations, each respective leg in the plurality of legs 108 includes: one or more bodies, a proximal end rotatably coupled to the frame, and a distal end. In some implementations, each respective leg in the plurality of legs 108 includes: two or more bodies including a proximal body with a proximal end rotatably coupled to the frame, and a distal body with a distal end. The proximal body is coupled to the distal body with a joint in the second plurality of joints 112.

In some implementations, the plurality of supports 114 includes four supports. As shown, plurality of supports 114 includes front right support 114-A and a rear right support 114-B. Not shown are a front left support (C) and a rear left support (D). This ABCD convention can be applied to the plurality of legs 108, first plurality of joints 110, and the second plurality of joints 112. The pose of vehicle 100 allows for a better illustration of parts previously disclosed and described. For example, vehicle 100 includes leg 108-A which includes a first respective body in a proximal location coupled to frame 102 and joint 112-A; and a second respective body coupled to joint 112-A and support 114-A. To the rear of vehicle 100 includes leg 108-B which includes a first proximal body coupled to frame 102 by joint 110-B and to joint 112-B. Leg 108-B further includes a second distal body coupled to joint 110-B and support 114-B.

Vehicles described herein such as vehicle 100 may move between two or more poses. In both views shown in FIG. 1 and FIG. 2 vehicle 100 is facing right. Vehicle 100 in the first pose (FIG. 1) is arranged with one or more of the plurality of supports 114 closer to frame 102. Vehicle 100 in the second pose (FIG. 2) has one or more of the plurality of supports 114 further from frame 102. In some embodiments, the offset from frame 102 is principally in the vertical direction. A pilot in vehicle 100 provides input to controls 104 which in response motivates actuators to drive a plurality of joints, e.g., the first plurality of joints 110 and the second plurality of joints 112 to move between poses.

As further described herein the pilot may independently control the height of each support. For example, support 114-A may be set a different height than other supports. The height for support 114-A is denoted by H_{A}. Height is measured from the underside of frame 102 to the bottom of a respective support. Clearance is measured from underlying surface to bottom of the respective support.

The poses shown in FIG. 1 and FIG. 2 have frame 102 level and square front-to-back and side-to-side. However, in some implementations, it is desirable to place frame 102 off-level or out-of-square with respect to the underlying surface. This could include frame 102 levelling or anti-leveling. For example, with a side hill, a pilot may effect a roll by setting supports 114 at unequal heights with respect to the sagittal plane (coplanar with the plane of the drawing sheet); unequal lateral heights. As well, a pilot can effect passive steering with unequal lateral heights. In some conditions, a pilot may pitch frame 102 but setting different heights across the coronal plane.

Turning to FIG. 3 which shows vehicle 100 in accordance with the systems, devices, articles, and methods of embodiments described herein. FIG. 3 shows vehicle 100 in plan view. Vehicle 100 includes frame 102, plurality of legs 108, plurality of supports 114, a first motor 302, and a second motor 304. The plurality of legs 108 includes a front right leg 108-A, a rear right leg 108-B, front left leg 108-C, and rear left leg 108-D. The plurality of legs 108 are coupled to a plurality of supports 114, for example, support 114-A, support 114-B, support 114-C, and support 114-D. The lateral positions of support 114-A and support 114-C are wider than for support 114-B and support 114-D.

In some implementations, vehicle 100 includes direct-drive wheels. For example, vehicle 100 includes a first motor 302 rigidly coupled to leg 108-A and coupled to drive a wheel coupled to a distal part of leg 108-A. For example, support 114-A is a wheel. In some implementations, the direct drive wheels are on the same side of the coronal plane (e.g., both forward, both back). In some implementations, vehicle 100 includes a second motor 304 rigidly coupled to the leg 108-C and coupled to and configured to drive a wheel coupled to leg 108-C.

In some implementations, the pilot steers vehicle 100 through differential input to at least two motors coupled to drive wheels, endless tracks, and other driven rotatory supports disposed on different sides of vehicle 100.

Turning to FIG. 4 which shows vehicle 100 in an elevation view from one end. Vehicle 100 includes frame 102, harness 106, and plurality of supports 114. FIG. 4 also shows pilot 402 shown dismounted from vehicle 100.

Turning to FIG. 5 which shows an exemplary vehicle 500 in accordance with the systems, devices, articles, and methods of embodiments described herein. Vehicle 500 is an example of a vehicle that provides one or more aspects of the disclosure. Various components of vehicle 500 described or shown are optional in presence or number (e.g. omitted, present in a plurality, present singly), or may be split or combined according to various embodiments described herein. Vehicle 500 includes frame 102, plurality of controls 104 for a pilot 502, and a plurality of legs 108. The plurality of legs 108 are rotatably coupled to frame 102. In some embodiments, vehicle 100 includes a plurality of supports 114 coupled to the distal ends of respective legs in the plurality of legs 108.

Vehicle 500 includes a plurality of actuators 504 associated with the plurality of legs 108 and communicatively coupled to plurality of controls 104. An actuator in the plurality of actuators 504 moves in response to a signal from a control in the plurality of controls 104. A respective actuator in the plurality of actuators 504 is associated with a respective leg in the plurality of legs 108. For example, actuator 504-B is associated with the right-rear leg 108-B. In some implementations, vehicle 500 includes a power plant 506 to drive vehicle 500, e.g., drive actuators 504, or vehicle 500.

Vehicle 500 can move between a plurality of poses. For example moving from the squat position shown in FIG. 5 to another In some embodiments, in response to the motion of the respective actuator, the respective leg in the plurality of legs 108 changes between a first pose characterized by a first position of the distal end of the respective leg and a second pose characterized by a second position of the distal end of the respective leg. That is, a leg in plurality of legs 108 moves independently. For an example, see FIG. 7.

Turning to FIG. 6 which shows vehicle 500 in accordance with the systems, devices, articles, and methods of embodiments described herein. Vehicle 500 is in a second pose different from the first pose shown in FIG. 5. Vehicle 500 includes frame 102, plurality of controls 104, plurality of legs 108, and plurality of supports 114. Pilot 502 operates vehicle 500 at plurality of controls 104.

The pose of vehicle 500 allows a better view of plurality of legs 108 including leg 108-A and leg 108-B. The pose of vehicle 500 allows a better view of plurality of actuators 504 including actuator 504-A and actuator 504-B. In some embodiments, the plurality of supports 114 includes support 114-A and support 114-B. Vehicle 500 has an average height H₀.

In some implementations, vehicle 500 includes ride height control. For example, the plurality of actuators 504, in response to the signals produced by the plurality of controls 104, change the vertical distance between frame 102 and an underlying surface supporting the vehicle. That is adjust average height H₀.

Turning to FIG. 7 which shows vehicle 500 in accordance with the systems, devices, articles, and methods of embodiments described herein. FIG. 7 shows, in perspective view, vehicle 500 in a third pose.

In some implementations, the vehicle 500 includes an active and independent suspension assembly for frame 102. In some implementations, suspension assembly for frame 102 includes plurality of controls 104, plurality of legs 108, and plurality of actuators 504. As shown in FIG. 7, support 114-A is at height H_{A} relative to frame 102. Support 114-A, in this example a wheel, has corresponding clearance to ground C_{A}. The pilot 502 can through plurality of controls 104 raise support 114-A for various purposes including steering, leveling, active suspension, obstacle avoidance, and more.

As shown, pilot 502 for vehicle 500 may set different heights for a plurality of supports included in the plurality of supports 114. For example, in response to one or more inputs at the plurality of controls 104, a first actuator in the plurality of actuators 504 places the distal end of a first leg (e.g., leg 108-A) in the plurality of legs 108 to a first height relative to the frame 102 and the distal end of a second leg (e.g., leg 108-B) in the plurality of legs 108 remains at a second height relative to frame 102. The first height and the second height are unequal, e.g., different. For example, compare heights H_{A} and H_{B} and note H_{B} has no or little corresponding clearance.

Turning to FIG. 8 is a schematic diagram illustrating system 800 including pilot 502 and a plurality of controls 104. Various aspects of the vehicle have been removed from the instant view for the purposes of illustration including frame 102 and harness 106. The pilot 502 provides input to controls 104 through motion, force, or a combination. From the perspective for the pilot this may be a push, a pull, isometric exercise, isotonic exercise, or the like. In some implementations, pilot 502 provides input to the plurality of controls 104 through one or more pushes, pulls, isotonic motions, or the like

The plurality of controls 104 in response to the input from pilot 502 motivates one or more actuators to drive one or more joints and move at least one leg. The plurality of controls 104 may be one-to-one with the plurality of legs 108. For example, a first input on control 104-A, shown as a motion 802, motivates one or more actuators (e.g., actuator 504-B) to move leg 108-A. Likewise, a second input on control 104-B, shown as a motion 804, motivates one or more actuators to move leg 108-B. The first input is independent of the second input.

In some implementations, the controls include handles or other graspable controls, e.g., center stick, side stick, and lever. See, for example, control 104-A. In some implementations the controls include pedals. Implementations may include a mix of handles, other graspable controls, or pedals. See, for example, control 104-B. Some implementations include restraints for temporarily binding the pilot to the control. In some implementations, the plurality of legs 108 is underactuated with fewer corresponding controls than degrees of freedom. In such a vehicle pilot 502 can use their own degrees of freedom for other purposes, including balance or other functions, e.g., throttle, or brake.

In some implementations, pilot 502 feels force and positional feedback at plurality of controls 104. The force and positional feedback come from position and forces on plurality of legs 108, associated actuators, and plurality of controls 104. For example, with isotonic controls, plurality of controls 104 measure force, not position, to generate signals for the actuators 504. Plurality of controls 104 include a substantial degree of positional tracking, or parity with plurality of legs 108. This creates positional feedback that effectively doubles as force feedback because if pilot 502 pushes (force domain), and a respective leg in the plurality of legs 108 doesn't move (position domain), pilot 502 is aware the respective leg is stuck (force domain). Thus pilot 502 gains force information through positional responses of plurality of legs 108 and plurality of actuators 504. Feedback is further explained in reference to FIG. 9.

FIG. 9 is a schematic diagram illustrating a part of a vehicle including active and passive suspension. System 900 includes pilot 502 detachably coupled to plurality of controls 104 and providing input 902 to plurality of controls 104. In response to input 902, the plurality of controls 104 generates at least one signal for one or more actuators. The plurality of controls 104 is mechanically coupled to frame 102 and communicatively coupled through communication channel 906 to one or more active suspension elements 912. The one or more active suspension elements 912 (e.g., actuator, actuator 504) are mechanically coupled to frame 102 and can, for example, be part of plurality of legs 108.

The one or more active suspension elements 912 are mechanically coupled to one or more passive suspension elements 914. In some implementations, active suspension elements 912 and passive suspension elements 914 are in series to cooperatively support the vehicle (e.g., vehicle 100, vehicle 500). The one or more active suspension elements 912 may be one or more actuators as described herein in relation to, for example, FIG. 5 and FIG. 10.

The one or more passive suspension elements 914 are mechanically coupled plurality of supports 114. For example, plurality of supports 114 are wheels as shown in FIG. 1 or FIG. 5. The one or more passive suspension elements 914 may be a shock as described herein in relation to, for example, FIG. 10.

System 900 provides feedback to plurality of controls 104 and pilot 502. Feedback includes the pose of plurality of supports 114 or a force on plurality of supports 114, such as a collision. The feedback travels through passive suspension elements 914, active suspension elements 912, a communication channel 908, and presents to pilot 502 as feedback 920.

FIG. 10 is a technical diagram in elevation and detailed view illustrating a part 1000 of a vehicle including an actuator 1002 and a shock 1004. To orient yourself, consider FIG. 10 as a detailed view of the right-rear quarter of vehicle 500 shown in FIG. 5 but note part 1000 may not be included in a vehicle depending on the implementation. In some implementations, actuator 1002 is an actuator in communication with a control (e.g., control 104-B not shown). The shock 1004 provides passive suspension. Each leg 108 in a vehicle (e.g., leg 108-B) may include both an actuator 1002 and a shock 1004.

In some implementations, actuator 1002 is an active suspension element which protects frame 102 and other parts of the vehicle (e.g., vehicle 100, vehicle 500) from forces on leg 108-B. In some other implementations, shock 1004 protects frame 102 and other parts of the vehicle (e.g., vehicle 100, vehicle 500) from forces on leg 108-B through passive suspension. Passive suspension may include damping and stiffing as provided by constrained fluid motion, friction, or springs. In some other implementations, actuator 1002 and shock 1004 work cooperatively.

In some implementations, one or both of actuator 1002 and shock 1004 are mechanically and rigidly connected to form one long unit, e.g., a pin joint. In some implementations, actuator 1002 and shock 1004 are formed in one component, e.g., a column with both passive and active axial compliance sections.

In some implementations, part 1000 could include a link 1006 between actuator 1002 or shock 1004 and frame 102 or leg (e.g., leg 108-B), such that actuator 1002 and shock 1004 don't buckle. For example, link 1006 has a swinging coupling with frame 102 and in a slip fit engagement with actuator 1002 and shock 1004. In some implementations, link 1006 is mechanically coupled to leg 108-B and actuator 1002 or shock 1004.

Embodiments can be a kit. A kit is generally understood as a product including two or more components, typically distributed in a package, and optionally instruction on how to assemble or use. The components work together for a specific purpose, or to achieve a specific result, e.g., cooperate once assembled. Kits are useful in vehicles in bespoke manufacture, repair, and modification. A kit may be regarded as a “disassembled embodiment”, “advantageous implementation” or the like.

Further implementations are summarized in the following examples.

### Example 1

A suspension system including a body including a proximal end and a distal end, and a support mechanically coupled to the distal end of the body. The suspension system further includes a shock mechanically coupled to the body and in response to a force on the support lessens the effect of the force on the proximal end of the body, and an actuator mechanically coupled in series with the shock, and in response to a control signal, moves the support away from the proximal end of the body.

### Example 2

The system of Example 1 where the actuator in response to the force on the support lessens the effect of the force on the proximal end of the body.

### Example 3

The system of Example 1 further including a control in communication with the actuator, which, in response to an input on the control generates the control signal, and wherein the actuator provides feedback to a pilot at the control.

### Example 4

The system of Example 1 where the feedback is positional feedback or force feedback.

### Example 5

The system of Example 1 where the support is selected from the group consisting of ball caster, caster, endless track, foot, pontoon, ski, spike, and wheel.

### Example 6

A kit including the suspension system of Example 1.

### Example 7

A vehicle including a frame, a terrain-engaging mechanism, a passive suspension element mechanically coupled to and between the frame and the terrain-engaging mechanism, and an active suspension element in series with the passive suspension element. The active suspension element includes an actuator that in response to a control signal applies a force to move the terrain-engaging mechanism under normal load. In some implementations, the active suspension element augments the suspension dynamics of the passive suspension. The vehicle in some implementations includes a pilot control for providing a signal to the active suspension element and receiving feedback from the active suspension element.

For methods taught herein, the various acts may be performed in a different order than that illustrated or described. Additionally, the methods can omit some acts, combine acts, split an act, and/or employ additional acts. For methods taught herein, the various acts may be performed by one or more circuits, for instance one or more hardware processors.

The word “a” or “an” when used in conjunction with the terms “comprise”, “include”, “comprising”, or “including” in the claims or the specification may mean “one”, “one or more”, “at least one”, and “a plurality” unless the content dictates otherwise. Similarly, the word “another” means “additional” or “at least a second” unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A vehicle comprising:
a frame;
a plurality of controls coupled to the frame which in response to input from a pilot provides signals;
a plurality of legs coupled to the frame, each respective leg in the plurality of legs includes:
one or more bodies,
a proximal end rotatably coupled to the frame, and
a distal end; and
a plurality of actuators associated with the plurality of legs communicatively coupled to the plurality of controls, wherein:
a respective actuator in the plurality of actuators moves in response to a signal from a respective control in the plurality of controls,
the respective actuator in the plurality of actuators is associated with a respective leg in the plurality of legs, and
in response to the motion of the respective actuator, the respective leg in the plurality of legs changes between a first pose characterized by a first position of the distal end of the respective leg and a second pose characterized by a second position of the distal end of the respective leg.

2. The vehicle of claim 1, wherein the plurality of controls, the plurality of legs, and the plurality of actuators form an active and independent suspension assembly for the frame.

3. The vehicle of claim 1, wherein the first position of the distal end of the respective leg is displaced from the second position of the distal end of the respective leg in the vertical direction.

4. The vehicle of claim 1, wherein the plurality of actuators in response to the signals produced by the plurality of controls change a vertical distance between the frame and an underlying surface supporting the vehicle.

5. The vehicle of claim 1, wherein the plurality of actuators in response to the signals produced by the plurality of controls change an angle between the transverse plane of the frame and a reference plane.

6. The vehicle of claim 1, wherein in response to one or more inputs at the plurality of controls, a first actuator in the plurality of actuators places the distal end of a first leg to a first height relative to the frame and the distal end of a second leg in the plurality of legs remains at a second height relative to the frame, wherein the first height and the second height are unequal.

7. The vehicle of claim 1 further comprising:
a plurality of passive suspension elements placed in series with the plurality of legs.

8. The vehicle of claim 1 further comprising:
a plurality of supports, wherein:
a respective support in the plurality of wheels is coupled to the distal end of a respective leg, and
the respective support is selected from the group consisting of ball caster, caster, endless track, foot, pontoon, ski, spike, and wheel.

9. A suspension system comprising:
a body including a proximal end and a distal end;
a support mechanically coupled to the distal end of the body;
a shock mechanically coupled to the body and in response to a force on the support lessens the effect of the force on the proximal end of the body; and
an actuator mechanically coupled in series with the shock, and in response to a control signal, moves the support away from the proximal end of the body.

10. The system of claim 9 wherein the actuator in response to the force on the support lessens the effect of the force on the proximal end of the body.

11. The system of claim 9 further comprising a control in communication with the actuator, which, in response to an input on the control generates the control signal, and wherein the actuator provides feedback to a pilot at the control.

12. The system of claim 11 wherein the feedback is positional feedback or force feedback.

13. The system of claim 9 wherein the support is selected from the group consisting of ball caster, caster, endless track, foot, pontoon, ski, spike, and wheel.

14. A kit including the suspension system of claim 9.
